(19) United States
(12) Patent Application Publication
(10) Pub. No.: US 2023/0377115 A1
(43) Pub. Date: Nov. 23, 2023

(54) ANTI-TAMPER PROTECTION USING DENDRITES

(71) Applicant: Arizona Board of Regents on behalf of Arizona State University, Scottsdale, AZ (US)

(72) Inventor: Michael N. KOZICKI, Phoenix, AZ (US)

(21) Appl. No.: 18/030,839

(22) PCT Filed: Oct. 11, 2021
(86) PCT No.: PCT/US2021/054367

§ 371 Date: Apr. 7, 2023

Related U.S. Application Data
(60) Provisional application No. 63/090,076, filed on Oct. 9, 2020.

(51) Int. Cl. G06T 7/00; G06T 7/60

(52) U.S. Cl. CPC G06T 7/0002; G06T 7/60; G06T 2207/20081; G06T 2207/30024

(57) ABSTRACT

Assessing distortion of a dendrite includes obtaining an optical image of the dendrite, assessing geometric features of the dendrite based on the optical image, comparing the geometric features of the dendrite to corresponding geometric features of a corresponding undistorted dendrite, assessing a distortion of the geometric features of the dendrite relative to the corresponding geometric features of the corresponding undistorted dendrite, and identifying the dendrite as distorted if the distortion exceeds a threshold value. The geometric features can include branches, angles between branches, and thicknesses of branches. The distortion can include alteration of a length of a branch of the dendrite, alteration of an angle between branches of the dendrite, alteration in a thickness of a branch of the dendrite, or a discontinuity in a branch of the dendrite. Obtaining the optical image comprises irradiating the dendrite with polarized or unpolarized light.

### CROSS-REFERENCE TO RELATED APPLICATION

This application claims the benefit of U.S. Patent Application No. 63/090,076, filed on Oct. 9, 2020, which is incorporated by reference herein in its entirety.

### TECHNICAL FIELD

This invention relates to anti-tamper protection using dendrites.

### BACKGROUND

Most supply chains have a non-secure connection between items in the channel and corresponding information in a database, typically in the form of labels with machine-readable symbols (barcodes, etc.). These labels can be removed from genuine articles or copied and applied to fake or substandard items to misrepresent origin and quality. To protect supply chains from such wrongdoing, an incorruptible physical identifier that securely links items and information is needed. The incorruptible physical identifier is preferably unclonable and resistant to tampering, such as physical alteration and removal and reuse. In addition, a unique identifier can allow an unambiguous mapping between each item and its corresponding information in the database to further confound counterfeiting and allow hyper-specific or tightly targeted information to reach the consumer.

### SUMMARY

This disclosure describes methods for anti-tamper protection using dendrites. Localized distortion of a dendrite on a label can be detected, and comparison of features of the distorted dendrite with the undistorted dendrite can be used to assess tampering with the label. The labels can be used on tags for range of articles, such as food, produce, manufactured goods, and pharmaceuticals.

In a general aspect, assessing distortion of a dendrite includes obtaining an optical image of the dendrite, assessing geometric features of the dendrite based on the optical image, comparing the geometric features of the dendrite to corresponding geometric features of a corresponding undistorted dendrite, assessing a distortion of the geometric features of the dendrite relative to the corresponding geometric features of the corresponding undistorted dendrite, and identifying the dendrite as distorted if the distortion exceeds a threshold value.

Implementations of the general aspect can include one or more of the following features.

In some cases, wherein the threshold value is at least 10% of the corresponding value of corresponding undistorted dendrite. In some implementations, the geometric features can include branches, angles between branches, and thicknesses of branches. The distortion of a dendrite can include an alteration of a length or thickness of a branch, an alteration of an angle between branches, or a discontinuity in a branch. The image can be obtained by irradiating the dendrite with polarized or unpolarized light. Obtaining the optical image of the dendrite can include taking a photograph. In some cases, the photograph is taken with a cell phone. In certain cases, the corresponding geometric features are accessed via an application on the cell phone.

In some implementations, the corresponding features of the corresponding undistorted dendrite are stored in a database. Assessing the distortion can include assessing a probability that differences in the geometric features of the dendrite and the corresponding features of the corresponding undistorted dendrite are attributed to severing or stretching a branch of the dendrite. After identifying the dendrite as distorted, an item to which the dendrite is coupled can be identified as compromised.

In some cases the dendrite can be metallic or include metallic particles. In some cases the dendrite can be polymeric, optically transparent, include an acrylic polymer, or a combination thereof.

In some implementations, the first general aspect can include training a system to recognize the distortion of the geometric features of the dendrite. One or more of the geometric features of the dendrite can be altered to yield a reference distorted dendrite. An optical image of the reference distorted dendrite can be obtained. The geometric features of the reference distorted dendrite can be assessed and compared with the corresponding geometric features of the dendrite. In some implementations, obtaining the optical image of the reference distorted dendrite includes taking a photograph of the reference distorted dendrite. Based on the comparing, a difference in a selected geometric feature of the dendrite and corresponding feature of the references distorted dendrite can be identified. In some cases, altering one or more of the geometric features of the dendrite can include stretching or breaking a branch of the dendrite, removing the substrate from a surface, severing a portion of the substrate, or a combination thereof. In some cases, the selected geometric features can include a length of a branch, an angle between branches, a thickness of a branch, or a discontinuity of a branch of the dendrite.

The methods and systems relating the use of dendrites to detect tampering with labels as described in this disclosure have various advantages. The complexity and malleability of dendrites formed by electrodeposition of metal have natural anti-tamper qualities and retain evidence of damage, tampering, or removal. For multi-fluid dendrites, distortion during removal of a label can result in permanent lengthening of dendrite features along a particular axis. If the label is re-used, this damage would be visible during subsequent inspection, especially when the tampered version is compared with the original image. Identification and verification using the methods described here can be achieved by mobile imaging, with trustworthy image analytics rooted in geometry and topological methods, so that tracking can be performed throughout a supply chain. The use of global cell phone infrastructure is advantageous at least in part due to ready accessibility and ease of data sharing.

The details of one or more embodiments of the subject matter of this disclosure are set forth in the accompanying drawings and the description. Other features, aspects, and advantages of the subject matter will become apparent from the description, the drawings, and the claims.

### BRIEF DESCRIPTION OF DRAWINGS

FIG. 1 is a flow chart showing a series of steps for identifying an article tagged with a dendritic tag.

FIG. 2A is a contrast-adjusted image of a dendritic structure. FIG. 2B is an image of the dendritic structure of FIG. 2A, with identified features of the dendritic structure overlaid on the image. FIG. 2C is a schematic diagram showing features identified for the dendritic structure of FIG. 2A.

FIG. 3A is an image of a dendritic structure that is used to train an algorithm for dendritic structure feature recognition. FIG. 3B is an image of a dendritic structure, with features of the structure identified by a trained algorithm overlaid on the image.

FIG. 4 is a photomicrograph of a silver dendritic structure formed on a nickel cathode.

FIG. 5 depicts multi-fluid dendrite formation by interaction of fluids between two substrates.

FIG. 6 depicts continuous formation of multi-fluid dendrite formation.

### DETAILED DESCRIPTION

Methods and systems for authenticating unique stochastically branching patterns that are relatively dense but with fine features and diffusion-limited aggregation (DLA)-like branching (e.g., Brownian trees) or densely branching morphologies (DBM) are disclosed. Pattern variations in dendrites arise from mechanisms involved in formation of the dendritic structure. Formation of dendritic structures can be achieved by a variety of processes, including electrochemical and multi-fluid methods, and yield dendrites formed of materials including metals and organic polymers. In some cases, a plurality of members extending away from a common point of the dendritic structure to form a stochastically branched arrangement of the members, wherein regions of the dendritic structure are stochastically self-similar to the entire dendritic structure.

With a robust identification and verification process, dendrites can be used as unique and trusted identifiers for any type of traceable item. Identification and verification can be achieved by mobile imaging, with trustworthy image analytics rooted in geometry and topological methods, so that tracking can be performed throughout a supply chain. In one example, mobile imaging can be achieved with a cell phone. The use of global cell phone infrastructure is advantageous at least in part due to ready acessibility and ease of data sharing.

The number of possible patterns depends on the fractal dimension of the shape (related to its complexity and density), the magnification and resolution of the measurement technique used to examine the dendrite, and the mathematical basis of the reading scheme. Thus, the number of possible patterns is vast, even for dendrites “read” by a cell phone camera, allowing a different dendrite to be created for every item produced, mined, grown, or manufactured over any reasonable timeframe. Computationally, fractal-structures in dendrites can be represented accurately by topological analysis methods. Topological features are robust to conditions typical in mobile imaging, such as changes in lighting, viewpoint, noise, and blur.

In some embodiments, dendritic structures can be read optically. To implement optical reading, the pattern of the dendritic structure is interrogated using light, which can include wavelengths within and/or outside the visible spectrum, to produce a unique signal. For example, camera imaging may be used to obtain a detailed picture of the dendritic pattern. The acquired pattern can then be algorithmically analyzed to produce a unique code or identifier associated with the dendritic structure that acts as a type of “fingerprint”. Cell phone cameras can be used to capture images that are analyzed to identify the dendritic structure.

Various levels of detail may result from optical imaging, depending on the magnification and numerical aperture of the lenses used. For example, using a lens with a high numerical aperture, the focal plane may be swept along the z-axis (i.e., the axis normal to the main surface over which the dendritic structure extends) to reveal fine topographical details of the dendritic pattern.

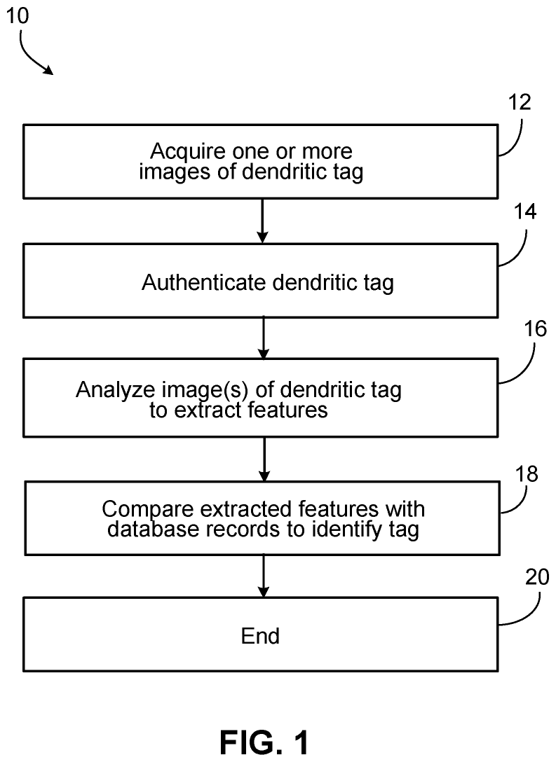

FIG. 1 is a flow chart 10 showing a series of steps for identifying an article tagged with a dendritic tag. In the first step 12, one or more images of the dendritic tag are acquired. The images can be acquired using a variety of image capturing devices including, for example, a mobile telephone with or without an imaging module.

Next, in step 14, the dendritic tag is authenticated. In the context of this disclosure, authentication refers to the process of verifying that the dendritic tag is an actual dendritic tag and not a copy or replica of a tag. As discussed above, dendritic structures have three-dimensional fractal structure. In contrast, many two-dimensional copies or replicas have only two-dimensional structure. This difference in dimensionality can be used to authenticate tags featuring dendritic structures.

In particular, to verify that a structure is indeed a dendritic structure, multiple images of the structure can be obtained using low angle illumination from different angles. A dendritic structure—which includes features that extend in the perpendicular direction—reflects light from its different facets in the perpendicular direction. Accordingly, “bright” regions in the multiple images will change as a function of the angle of illumination.

Using similar illumination and image capture techniques for dendritic tags, images of the dendritic structures therein can be obtained from multiple illumination angles. In some embodiments, color filters can be used to filter the illumination light so that the illumination light is distinguishable from ambient light in images of the dendritic tags. By filtering the illumination light (e.g., light generated from an illumination source such as a flash unit of a mobile telephone), only the edges of the dendritic structure that face the illumination source are illuminated with the filtered light, and therefore appear in a different color than other features in the image. In addition to, or as an alternative to, obtaining multiple images from different illumination directions, the device used to image the dendritic tag can also record video of the dendritic tag illuminated from different directions, showing a varying pattern of illumination as the illumination direction changes.

Analysis of the images can be performed to determine whether different features of the structures are highlighted as the illumination direction varies by determining which regions appear brightest in each of the images. In some embodiments, for example, as the reflected light changes with illumination angle, a three-dimensional representation of the outer facets of the dendritic feature can be constructed to convert intensity and position of the reflected light to the angle, height, and position of the reflecting surfaces to verify that the features of the dendritic structure are indeed three-dimensional in nature, and not two-dimensional. If the angles and heights of the reflecting surfaces all lie within a thin planar region, the likelihood that the structure is a copy rather than a true dendritic structure is increased. The distribution of angles and/or heights can be compared to a threshold value or distribution to determine whether a particular dendritic structure contained in the tag is authentic or not.

Alternatively, in some embodiments, the observed changes in reflected light angles and positions as a function of illumination direction are sufficient to establish that a dendritic structure is three-dimensional. The distribution of reflected light angles and/or positions can be compared to a threshold value or distribution for purposes of establishing an authentication of the dendritic structure contained in the tag.

In either of the methods disclosed above, image processing is typically be performed in the device that captures the images. In some embodiments, however, some or all of the image processing functions can be performed by one or more remote computing devices (e.g., one or more remote servers) by transmitting some or all of the acquired images at various illumination directions and/or angles to the remote device. Alternatively, or in addition, video of the changing light reflection as a function of illumination angle and/or direction can be transmitted to the remote computing device and used to authenticate or reject the dendritic tag.

In certain embodiments, reflected light images obtained by illuminating the dendritic structures with different colors of light can provide additional information that can be used to authenticate the structures. For example, when the device used to illuminate the structures includes a tunable laser-based source, reflected light images corresponding to both different illumination directions and different illumination wavelengths can be obtained. Even when illumination occurs from a common direction, when the illumination light is of a different wavelength, reflected light images of certain dendritic structures may appear different, and these differences indicate that what is being imaged is a true three-dimensional dendritic structure, not a two-dimensional copy.

In some embodiments, the three-dimensional nature of the dendritic structure can be further confirmed by comparing the differing patterns of reflected light to database records that include patterns of reflected light, as a function of illumination direction, for authentic dendritic tags. For example, the measured reflected light patterns can be decomposed to identify “sources” of reflected light in each image, each source having a position, a size, and an integrated intensity. Some or all of these attributes of the identified sources can then be compared to similar information derived from database records to determine whether the observed reflected light images match a particular database record, thereby authenticating the tag from which the images were measured. As described above, the database records can also include patterns of reflected light that correspond to illumination with different wavelengths of light, and this information can also be used together with, or as an alternative to, information derived from images corresponding to different illumination directions to authenticate specific dendritic structures.

Using the foregoing methods, a dendritic tag applied to an article can be either authenticated as genuine, or rejected as a likely counterfeit copy or replica. Returning to FIG. 1, if the dendritic tag attached to the article is authenticated, then in step 16, the image(s) of the dendritic tag are analyzed to extract features of the dendritic structure in the tag. In general, each of the analysis steps disclosed herein can be performed by the device used to acquire the tag image(s), or by one or more remote computing devices (e.g., one or more servers), after the image(s) has/have been transmitted to the remote device from the image capture device.

As a first step in the analysis, a captured image is typically adjusted to filter extraneous features and produce a line segment representation of the dendritic structure. The adjustment can take a variety of forms. In some embodiments, the image is adjusted by altering the contrast and/or brightness of a grayscale version of the image so that a thinned representation of the dendritic structure is produced. One or more reference patterns printed on the dendritic tag can be used for this purpose. For example, the contrast and/or brightness of the image can be altered so that two adjacent reference patterns on the tag have a particular separation between them. The contrast and/or brightness of all images of the same dendritic tag can then be adjusted so that in each image, the separation between the two reference patterns is the same.

Alternatively, or in addition, in some embodiments edge detection algorithms can be used on a captured image to highlight the edges of the dendritic patterns and the thinned (line) version of the image is produced by positioning lines of a single thickness at the mean positions between paired edges. Lines may also be positioned at the mean positions between paired edges, where the thickness of the lines depends on the spacing between the edges. During the production of thinned or line segment images from the original acquired images, curved segments can be replaced with sequences of straight lines to facilitate faster image analysis and digitized image comparison.

Line segments in the thinned image are not necessarily straight, but will typically begin and end on minutiae, which are branching points or terminations that appear in the pattern defined by the dendritic structure. A variety of different dendritic pattern coding schemes for the analysis of the images can be used; a coding scheme is used to identify minutiae by position and type in an image of the dendritic structure. An example of a coding scheme for minutiae types is shown in Table 1.

TABLE 1
Coding scheme for minutiae types

| Designation | Type | Description |
|---|---|---|
| C | Center or | Center or Origin of dendritic structure and |
| | Origin | origin of all trunks (position of growth |
| | | cathode) |
| N | N-branch | N^{th} branching point, bifurcation, or angular |
| | | bend after start point in a trunk |
| T | Termination | End point of any non-continuing line |
| | | segment |
| I | Isolation | Isolated point or start (i.e., closest to |
| | | Center or Origin) of isolated line segment or |
| | | branch |
| Z | High Z | Element that appears brighter due to larger |
| | | height in perpendicular direction than |
| | | average |

In addition to the minutiae types above, fiducials can be printed on a dendritic tag. Fiducials can be used for a number of important functions. In some embodiments, fiducials can be used to indicate directions from which tags can be illuminated to obtain reflected light images of the dendritic structure(s) therein, as described above, to authenticate the tags. The fiducials provide indicators for users who scan the tags as part of a supply chain, for example, to ensure that the images that are obtained correspond to images that were used to generate database information that was stored for the tags, and that is used later to authenticate and/or identify the tags.

In certain embodiments, fiducials are used as points of reference for the analysis of the dendritic pattern. As an example, for radial tags with a central growth point, the Center minutiae point can be the fiducial. Further, S vectors associated with the line segments of the dendritic pattern can be obtained through analysis. An S vector corresponds to a number set that defines the length and angle of a line segment that extends between two minutiae points (M points).

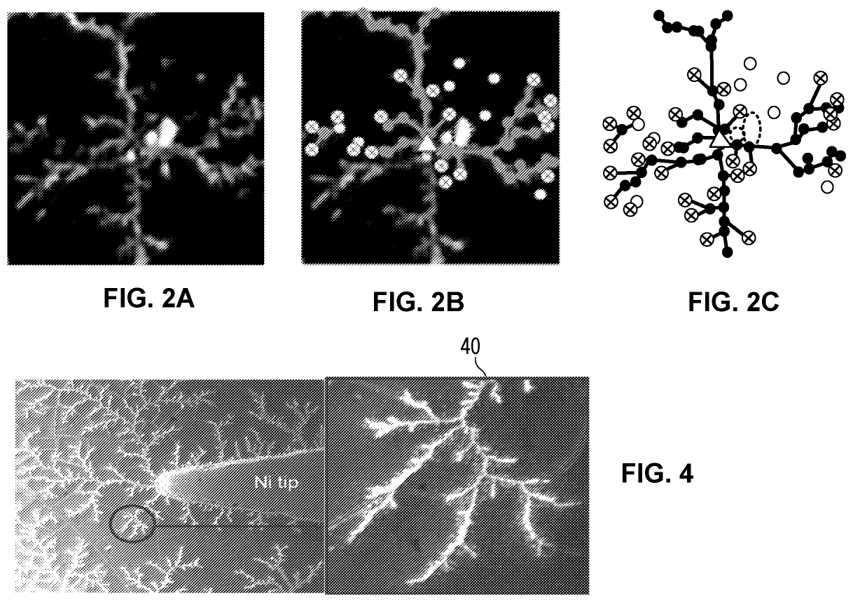

FIGS. 2A-2C show steps in the analysis of an image of a portion of a dendritic structure. In FIG. 2A, the contrast of the image has been adjusted to thin the image, reducing the representation of the dendritic structure to an apparent line pattern. In FIG. 2B, a partial analysis of the thinned image has been performed to identify minutiae points and line segments according to the coding scheme disclosed above. Line segments are overlaid on the image. Identified minutiae points are overlaid on the image as follows: Centers or Origins, open triangles; N branches, solid circles; Terminations, crossed circles; Isolations, open circles; and High Z points, dotted circles.

FIG. 2C shows the complete pattern of M points and line segments (S vectors) after analysis of the dendritic structure from FIG. 2A is complete. As shown in this figure, the dendritic structure has been reduced to a collection of features through the analysis, and further operations—such as identification of the dendritic structure—can be based on the set of identified features, rather than on the full image of the dendritic structure.

A variety of different analysis techniques can be used to perform the feature recognition shown in FIG. 2C. In some embodiments, for example, the scale-invariant feature transformation (SIFT) can be used. This technique transforms an image into a collection of vectors, each of which is invariant to translation, scaling, and rotation, and to a certain extent illumination changes and localized distortion. Image recognition algorithms of this type can be applied to raw images (e.g., without adjustment to thin the images) and are typically robust, particularly when training images are used. As such, these methods are well suited for identification of features in images of dendritic structures, which can be distorted by physical damage to the tag that includes the structure, and/or by imperfect imaging conditions.

FIG. 3A shows an image of a dendritic structure that is used to train a SIFT algorithm for dendritic structure feature recognition. Key training features in FIG. 3A have been identified to the algorithm by tagging with crosses. In FIG. 3B, the trained SIFT algorithm operates on a new version of the training image to identify features in the image corresponding to various types of M points. Specifically, in FIG. 3B, 108 points corresponding to features of the dendritic structure were automatically identified.

Returning to FIG. 1, after the set of features corresponding to the dendritic tag has been identified in step 16, the set of features is compared to records in a database in step 18 to identify the tag (and the article to which the tag is attached). Typically, this step is performed by a remote computing device to which the dendritic image(s) or extracted set of features have been transmitted. The remote computing device may also host the database, or be configured to access the database over a secured connection.

If the set of features obtained through analysis in step 16 is sufficiently accurate, than a unique match to only one database record will occur, uniquely identifying the tag. As discussed above, the database records are typically generated when dendritic tags are applied to articles and scanned, prior to manufacture, shipment, or storage of the tagged articles. Database records are maintained in secure storage to prevent unauthorized access and alteration, and therefore function as an analogue of a fingerprint database for tagged articles.

In general, comparison between the set of features obtained by analysis of images of a particular dendritic tag and database records will yield a number of potential matches. Various methods can be used to determine which of these potential matches is correct, and whether the match is sufficiently precise to properly identify the tag and the article to which it is attached. In the following paragraphs, one example of a method for comparing the set of features obtained from the dendritic images to database records is disclosed, although it should be appreciated that other methods can also be used.

In some embodiments, a hierarchical comparison can be performed between the set of features obtained by image analysis for a dendritic tag and database records to identify the tag. For example, the comparison begins from the center or origin of the dendritic pattern, and then extends in successive steps outward from the center or origin, i.e., from high dimensional features such as trunks and major branches to low dimensional features such as minor branches and twigs. For each successive feature, only database records that also contain such a feature (as well as all of the other higher-dimensional features identified for the tag) are further considered as possible matches. That is, at the beginning of the comparison, all of the database records are considered to be possible matches to the dendritic tag. As each successive feature of the tag is analyzed, the possible list of matching database records can be reduced by eliminating records that do not include the collective list of features analyzed to that point. Thus, analyses of each successive feature typically reduces the number of records that can correspond to a possible match (so that each successive analysis reduces the number of database records that are examined).

For example, a radial dendritic structure may have several trunks originating from the center. The angles between these trunks can be determined and used as the first several “levels” in the hierarchical comparison tree (i.e., only stored records which include this set of angles would be retained for consideration at subsequent levels in the comparison tree). The next several levels in the tree can be based on features such as the distance from the center of each trunk to the first major branch. Subsequent levels can be based on features such as the angles of these branches to their respective trunks. The foregoing provides examples of features which can be used to implement different levels of the comparison tree, but more generally, any of the features extracted from the captured images can be used, in any order.

In some embodiments, “box counting” methods can be used to generate a unique identifier for a dendritic structure that can then be compared to information in stored records for purposes of identification. Box counting methods are typically used to determine the fractal dimension of a dendritic structure, and are hierarchical in nature. In this approach, an image of the dendritic structure is divided into square boxes arranged in a grid pattern. The grid pattern can be aligned to fiducial marks applied to the tag that contains the structure.

Each box is then examined to determine whether or not it contains a portion of the dendritic structure. The output for this examination step is binary: each box is assigned a value of zero if the box includes no portion of the dendritic structure, and a value of 1 if the box includes a portion of the structure. Typically, in an initial scan, a fine-scale grid is used to digitize the image. Then, in subsequent pattern matching operations, a coarse-scale grid is used initially, and then the analysis is repeated with progressively finer-scale grids, e.g., halving the length of the box for each analysis step, to produce a unique data set to represent the dendritic structure.

The analysis corresponding to the coarsest-scale is used to reject all the stored patterns that do not match. Subsequent finer-scale grids are used to do the same, rejecting all non-matching patterns to reduce the time it takes to complete the matching process. Thus, box counting methods implement a hierarchical analysis, just as the feature-based methods discussed above.

The rate at which comparisons to stored patterns can be performed can be significantly increased in some embodiments by eliminating regions that correspond to no dendritic structure from further consideration as finer-scale grids are used. The selective elimination of such regions from further consideration is based upon the observation that if a particular region contains no dendritic structure at a coarse scale, then that region (and portions thereof) will also contain no dendritic structure at finer scales. Accordingly, such regions can be eliminated from further consideration at successively finer scales, which can significantly reduce analysis time at later levels of the hierarchical analysis scheme.

The comparison between identified features of the tag and database records, or the binary box counting analysis and database records, proceeds until all the non-conforming records are rejected and only one possible match remains. Since the dendritic structures are fractal in nature, this process is primarily limited by the magnification of the image acquisition optics; the higher the magnification used, the greater the number of features (and therefore, levels in the hierarchical comparison tree) as smaller and smaller features toward the ends of each branch can be included in the analysis. In general, the information density from the analysis increases according to the fractal dimension of the dendritic structure.

If the comparison results in no matches between the feature set corresponding to the tag and the database records, in certain embodiments the comparison between the feature set and the database records can be repeated, with relaxed measurement tolerances to obtain a match. In some embodiments, the device used to perform the comparison can prompt the user to re-scan the dendritic tag to obtain a new set of images, which can then be used to repeat the feature set analysis and comparison to database records. The new set of images can also be used to reduce measurement and/or acquisition errors in the original set of tag images, e.g., by combining the images to reduce noise and/or aberrations. As an example, the dendritic nature of the patterns allows defects in the acquired images to be rejected, as the line segments should be continuous and branching so that gaps and isolated truncated points can be ignored during the feature set analysis and subsequent comparison to database records. Captured image blurring can be compensated by the thinning process described above (e.g., by replacing the acquired image with line segments). Scale or magnification distortions can be overcome using Scale Invariant Feature Transform methods, as described above.

If the comparison is repeated and no matches are once again found between the feature set corresponding to the tag and the database records, the device can issue a warning (e.g., a visual and/or auditory message or alert) that the tag could not be properly identified, and may not be genuine.

If the comparison produces more than one possible match between the tag's feature set and the database records, then in some embodiments, the comparison can be repeated with tighter measurement tolerances to produce a more accurate match. In certain embodiments, the device used to perform the comparison can prompt the user to re-scan the dendritic tag to obtain a new set of images, which can then be used to repeat the feature set analysis and comparison to database records. The new images can also be combined with the previous images to reduce measurement and/or acquisition errors; the combined image information can then be used for the second comparison.

If multiple potential matches remain following the second comparison (and, possibly, additional subsequent comparisons), further information can be used to distinguish among the potential matches. In some embodiments, for example, contextual information can be used. Dendritic tags can be applied to a wide variety of different articles, and database records can include information relating not only to the features of the dendritic structures in the tags, but also to the articles to which the tags are applied. This contextual information can be used to distinguish among potential matches.

For example, suppose that two database records correspond to potential matches for a dendritic tag, but the first record includes information indicating that it corresponds to a tag applied to one type of article such as a pharmaceutical product, while the second record includes information indicating that it corresponds to a tag applied to a different type of article such as a meat product. If the tag that is being identified is attached to a pharmaceutical product, this contextual information can be used to readily identify the first record as a match, and to reject the second record.

In addition, information obtained from reflected light images can also be used to distinguish among multiple possible database records. As described above, reflected light images that correspond to different illumination directions and/or different illumination wavelengths produce distinctive reflected light patterns from dendritic structures. Information derived from images of these patterns (and/or the images themselves) can be stored in database records and used to distinguish among records having feature sets that nominally each correspond to the feature set of a dendritic tag that is subject to identification.

In the foregoing discussion, contextual and reflected light information are used to distinguish among possible database record matches after the hierarchical comparison has been performed. More generally, however, this additional information can be incorporated at any level into the hierarchical comparison to filter out possible matches from among the database records. For example, in some embodiments, this additional information can be used at the first level, or at one of the first five levels, of the hierarchical comparison. In certain embodiments, using contextual and/or reflected light information early in the hierarchical comparison can significantly reduce the number of database records that are considered at subsequent levels.

Following the comparison in step 18, the tag is either identified as genuine, or identification is deemed impossible, and the procedure ends at step 20. In either case, a message can be delivered to the user of the imaging device via a display screen. The user may be given the option of re-scanning the dendritic tag to attempt identification again.

In some embodiments, the set of features associated with analyzed image(s) of the dendritic tag can be stored in the database and marked as a record corresponding to an unknown and/or potential counterfeit article. Various criteria can be used for determining whether marking of the set of features should occur in the database. For example, the failure to produce any matches in the early levels of the hierarchical comparison is much less likely to be due to measurement/digitization errors and so is more likely to indicate a counterfeit tag, whereas such a failure in the advanced levels of the comparison could be due to measurement errors. Thus, records can be marked according to the first level at which no match between the tag's feature set and the database records occurs, with a threshold level value (e.g., 2 or 3) to establish whether the record is marked as a likely counterfeit. Records can be marked with a variety of information, including the date and/or location of the most recent comparison to other database records, the first level at which no match occurred between the tag's feature set and the other records, and the likely or suspected reason for the failure to match any records. By marking the record corresponding to the extracted feature set as corresponding to an unknown and/or potential counterfeit article, subsequent scans of the same tag can rapidly alert the user of the scanning device that the tagged article is suspect.

Hardware and Software Implementation

The algorithmic and method steps disclosed herein in connection with obtaining images of dendritic tags, analyzing the images, authenticating and identifying articles to which such tags are attached, and controlling various aspects and operating parameters of devices that obtain tag images and devices that utilize such tags, can be implemented in computer programs using standard programming techniques. Such programs are designed to execute on control units, programmable computers, and/or specifically designed integrated circuits, each comprising an electronic processor, a data storage system (including memory and/or storage elements), at least one input device, and least one output device, such as a display or printer. The program code is applied to input data to perform the functions described herein and generate output information, which is applied to one or more output devices, such as a user interface that includes a display device. Each such computer program can be implemented in a high-level procedural or object-oriented programming language, or an assembly or machine language. Furthermore, the language can be a compiled or interpreted language. Each such computer program can be stored on a tangible, computer readable storage medium (e.g., CD ROM or magnetic diskette) that, when read by a computer or other device, can cause the processor to perform the analysis and control functions described herein.

### Electrodeposited Dendrites

Electrochemical formation of dendrites lends itself to mass production via roll-to-roll processes. Examples of suitable metals for metallic dendrites include silver and copper.

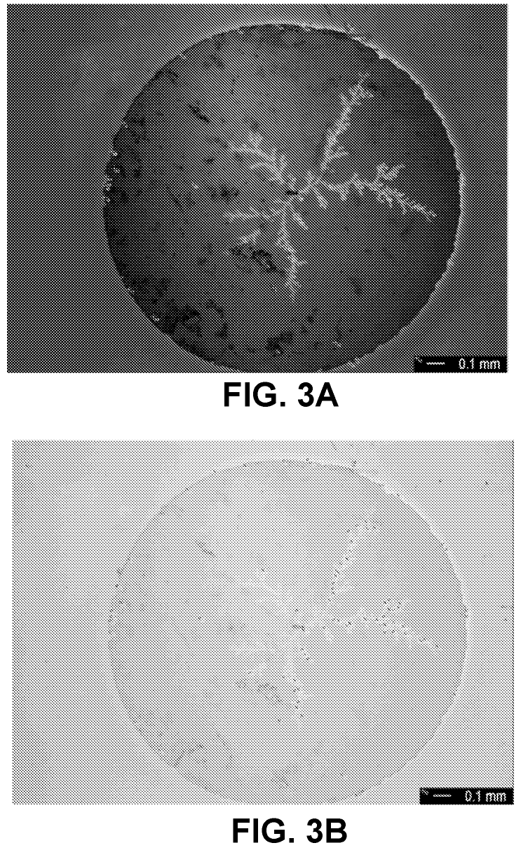

Electrodeposited dendrites have a two-dimensional dendritic topology as well as a micro- to nano-scale faceted relief. A photomicrograph of an example of a dendritic metal structure 40 is shown in FIG. 4, in which dendritic silver structures are grown from a nickel cathode. The dendritic topology as well as the faceted relief are both unique to each electrodeposit. This topology and relief yield a distinctive optical signal that can be detected using polarized light. The topology and relief are difficult to forge and prevent cloning of the dendrites. The amount of metal required for optically readable dendrites is extremely small, as the electrodeposits may be as large as a centimeter in diameter but are typically less than 100 nm in thickness. As a result, a typical electrodeposited dendrite includes less than a hundred nanograms are of silver.

Metallic dendritic structures can be formed by methods that include providing an ion conductor and two or more electrodes in contact with the ion conductor, and applying a bias voltage across the electrodes sufficient to grow the metallic dendritic metal structure in or on the ion conductor. The stochastic nature of the electrodeposition process leads to randomly-branched and randomly-faceted patterns each time a dendritic structure is grown on a new region of an ion conducting medium.

In the process of electrodeposition, metal cations in the liquid are reduced at the cathode. To replace the metal cations in the liquid and allow for continued growth of the dendritic metal structure, the anode can include the same metal as the metal of the dendritic metal structure. As the dendritic metal structure grows by reduction at the cathode, the anode is concomitantly oxidized and dissolved into the liquid, resulting in a net mass transfer from the anode to the growing dendritic metal structure. For example, the anode can be formed of silver, a silver alloy, copper or a copper alloy. When the metal is provided by the anode, the liquid need not have any metal ions dissolved in it when it is disposed on the surface of the substrate. By physically changing the anode material during growth, or by providing an electrical bias in sequence to anodes of differing composition, it is possible to grow a dendritic structure that includes multiple metals either as a mixture or as segments in the structure. Fabricating dendritic structures in this manner makes subsequent replication of the structures (i.e., in a separate growth process) very difficult.

In general, substrates used to support the dendritic structure can be rigid or flexible, and a wide range of different materials having different mechanical properties can be used as substrates. Typically, appropriate ion conductors and electrode materials are selected based on the type of substrate that is used.

High quality dendritic structures have been successfully grown on a variety of paper-based materials. Various methods can be used to fabricate dendritic structures on paper. In some embodiments, for example, a paper substrate (e.g., laboratory filter paper) is soaked in an electrolyte solution. While any of the electrolyte materials disclosed herein can be used to immerse the paper substrate, silver nitrate solutions have been found to yield good results. The concentration of the solution used is typically larger than 0.01 M, e.g., between 0.1 M and 1.0 M. A silver nitrate solution at a concentration of 0.1 M has been found to yield good results.

After the paper has been soaked, a cathode is positioned on the paper where the dendritic structure will be grown. Dendritic structures can be fabricated on the paper without applying an anode, since the metal ions that form the dendritic structure are present in the electrolyte solution taken up by the paper substrate. However, in certain embodiments, an anode can be positioned at another location (e.g., different from the cathode location) on the electrolyte-soaked paper.

Next, an electrical potential difference is applied between the cathode and the electrolyte in the paper or the anode (if the anode is present). Typically, a potential difference of approximately 10 V is applied for a few tens of seconds (e.g., between 10 s and 60 s) to grow the dendritic structure at the position of the cathode on the paper substrate. Following growth of the dendritic structure, the cathode (and anode, if present) are removed from the paper substrate, and the paper is dried.

Using paper-based substrates provides a number of important advantages. Paper is a low-cost material that is available in large quantities and a variety of different forms (e.g., compositions, textures, strengths). As a result, the nature of the paper selected for the substrate can be chosen based on the intended application; for example, stronger paper substrates can be selected for applications that are anticipated to involve more frequent mechanical handling of the dendritic structures.

Dendritic structures have also been observed to adhere well to paper-based substrates. The observed adherence may be due to the relatively rough surface of paper at the microscopic level. As papers with a wide variety of different textures can be used as substrates, adherence of the fabricated dendritic structure to the substrate can therefore be selected based on the choice of paper used for the substrate.

In addition, paper-based materials are typically porous and as a result, a variety of different electrolyte materials can be introduced into paper-based substrates using techniques such as immersion (e.g., soaking), as described above. Introducing electrolyte materials directly into the substrate significantly simplifies the growth process for the dendritic structures. Moreover, as described above, in some embodiments dendritic structures can even be grown without using an anode.

The methods disclosed herein for fabricating dendritic structures directly on paper-based substrates enable the use of dendritic structures as security-related elements in a variety of important security-related applications. The strong adherence of the dendritic structures to paper-based substrates makes removal of the dendritic structures from the documents difficult. Mechanical and/or chemical methods for removal, for example, are likely to lead to destruction of the dendritic structures, preventing identification of the documents on which they are grown.

In addition to paper-based substrates, a variety of porous substrates can be used for the fabrication of dendritic structures using techniques similar to those disclosed above. In fabrication methods involving such substrates, an electrolyte (e.g., a liquid, gel, or paste electrolyte) is applied to the substrate material by immersion, spraying, contact deposition, or a direct mechanical application. A cathode is applied to the substrate surface and electrolyte and, optionally, an anode can also be applied. An electrical potential difference is applied between the cathode and the electrolyte in the porous material (or the anode, if present) to grow the dendritic structure. Using such methods, the fabricated dendritic structures adhere very strongly to the porous substrate. It is believed that the strong adhesion occurs because the dendritic structures at least partially form in the pores or gaps of the substrate material, which physically “locks” the dendritic structures in place on the substrate surface. The foregoing fabrication methods are therefore particularly well suited to prevention of tampering with the dendritic structures, as the physical adhesion and “locking” of the structures to the porous substrate makes mechanical or chemical removal of the structures from the substrate—without damaging the structures—very difficult.

In addition to the desirable attributes listed above, electrodeposited metal dendrites also have natural anti-tamper qualities. In particular, complexity at the micro-scale makes it extremely difficult to “reassemble” a dendrite that has been split without leaving evidence of the repair. In addition to the difficulty involved in perfectly aligning the multitude of features in the pattern, the malleability of silver means that the branches will stretch prior to breaking, which further confound any attempt at reattachment. So, a dendrite that is part of a seal that becomes broken when an item it is attached to is opened or removed would have obvious detectable damage following the break.

The malleability of a metal (e.g., silver) means that it will retain any distortion that occurs if the label that it is placed upon becomes stretched, even slightly, during removal. A thin polyethylene (PE) or polypropylene (PP) label substrate with adhesive on the back, such as those used in price look-up (PLU) stickers in the fresh food industry, will tend to stretch when peeled off, thereby resulting in permanent lengthening of dendrite features along a particular axis. If the label is reused, the damage is visible during subsequent inspection, especially when the tampered version is compared with the original image. Damage sustained during tearing or stretching will be evident in a polarized light image, as well as the geometric distortion of the dendrite, providing multiple methods of detection.

These distortions will be most detectible during optical inspection (with unpolarized and polarized light). Feature-by-feature comparison with the original (undistorted) pattern can be used to detect such damage. In addition, machine learning (ML) can be used to train a system to recognize distortions caused by illicit breaking or removal. In this approach, two training sets, images of undistorted and distorted dendrites, can be used to define the parameters for system operation, so that a neural network can automatically detect and flag tampering issues.

Multi-fluid Dendrites

As described herein, “multi-fluid dendrites” generally refer to unique stochastically branching patterns fabricated by sandwiching a first fluid as a thin layer between two surfaces and then introducing a second fluid having a lower viscosity than the first fluid between the two surfaces. The surfaces can be planar or curved. Examples of suitable surface materials include glass and plastic (e.g., polyethylene terephthalate). In some embodiments, one of the surfaces is a label, a package, or any other item for which authentication is desirable. Patterning in one or more of the two surfaces (e.g., defects/pits/grooves) typically promotes more branching at the edges of the dendritic fingers. Surface irregularities can overcome the surface tension smoothing effect and allow small branches to grow. Regular patterns in one or more of the two surfaces can force branching to occur in a symmetric way if desired.

The dendritic structures described herein are fabricated by providing a first fluid between a surface of a first substrate and a surface of a second substrate, and introducing a second fluid between the surface of the substrate and the surface of the second substrate. The first substrate can be an item (e.g., a piece of produce or a consumer good). In some cases, the first substrate is a label (e.g., a produce label) or packaging. Suitable materials for the first and second substrates include glass, plastic (e.g., polyethylene terephthalate), metal (e.g., stainless steel), synthetic paper, and resin-coated paper. The first substrate, the second substrate, or both can be flexible (including stretchable) or rigid. The surface of the first substrate and the surface of the second substrate can be curved or substantially planar. In some cases, the surface of the first substrate, the surface of the second substrate, or both have a root mean square surface roughness of about 50 μm or less (e.g., for metals) or about 1 μm or less (e.g., for plastics). In some cases, the surface of the first substrate, the second substrate, or both have protrusions, recessions, or both. The first fluid may be in direct contact with the protrusions, the recessions, or both. In some cases, the protrusions and recessions form a repeating pattern in the surface of the first substrate, the second substrate, or both. Patterning in one or both of the surface of the first substrate and the surface of the second substrate typically promotes more branching at the edges of the dendritic structure. Surface irregularities can overcome the surface tension smoothing effect and allow small branches to grow. Regular patterns in one or more of the two surfaces can force branching to occur symmetrically.

Providing the first fluid between the first substrate and the second substrate can include disposing the first fluid on the surface of the first substrate and contacting the first fluid with the surface of the second substrate. The first fluid can be spread on the surface of the first substrate before introducing the second fluid. In some cases, the first fluid is in direct contact with the surface of the first substrate and the surface of the second substrate. In certain cases, the surface of the first substrate, the surface of the second substrate, or both have been treated (e.g., etched with an acid or base) or coated (e.g., with an adhesive material) before the first fluid contacts the surface of the first substrate.

Disposing the first fluid on the surface of the first substrate can include dispensing the first fluid from a nozzle or through a template to yield one or more drops of the first fluid on the surface of the first substrate. The drops typically have a volume of a few microliters (e.g., about 2 μL) to a few hundred microliters (e.g., about 400 μL). The nozzle can be driven by pressure pulses. In some cases, when the nozzle is part of an inkjet head, the nozzle can be driven by a piezo-electric mechanism. A suitable template defines openings sized and positioned to form droplets of a selected volume and spacing. In some cases, the first fluid is deposited in a pattern on the surface of the first substrate with a rotogravure. Disposing the first fluid on the surface of the first substrate can include disposing a single drop or a multiplicity of drops of the first fluid on the surface of the substrate. The drops can be sized and spaced such that the resulting dendritic structures are discrete or contact (e.g., grow into) each other to yield a continuous array of dendritic structures.

The surface of the first substrate and the surface of the second substrate at least partially confine the first fluid, and the surface of the first substrate and the surface of the second substrate are separated by the first fluid at a region between the surface of the first substrate and the surface of the second substrate, thereby allowing the second fluid to penetrate the first fluid at the region. Introducing the second fluid between the surface of the first substrate and the surface of the second substrate can include injecting the second fluid under pressure between the surface of the first substrate and the surface of the second substrate. In some cases, the first substrate and the second substrate (with the first fluid therebetween) is submerged in the second fluid (e.g., air).

Separating the first substrate and the second substrate can be achieved by increasing a distance between an edge of the first substrate and an edge of the second substrate such that the region translates away from the first edge of the first substrate and the first edge of the second substrate. After the second fluid is introduced between the surface of the first substrate and the surface of the second substrate and penetrates the first fluid, the second fluid is in direct contact with the first fluid. At the temperature at which the dendritic structure is formed (the “formation temperature”), a viscosity of the first fluid exceeds a viscosity of the second fluid. In some cases, the formation temperature is room temperature (e.g., around 20° C. to 28° C.). Separating the first substrate and the second substrate results in the formation of a unique stochastically branching pattern (a dendritic structure) from the first fluid on the surface of the first substrate. A mirror image of the stochastically branching pattern on the surface of the first substrate is formed from the first fluid on the surface of the second substrate. The dendritic structures on the first substrate and the second substrate are identical in shape (e.g., outline) and can differ, for example, in height or other physical properties due at least in part to inhomogeneous distribution of any particles that may be in the dendritic structures.

The dendritic structures on the first substrate, the second substrate, or both can be solidified to yield dendritic structures having a maximum dimension in a range of about 5 mm to about 5 cm. Methods of drying include evaporation of a solvent (e.g., water) in the first fluid, hardening the first fluid via a hardener, curing the first fluid with ultraviolet radiation, crystallizing the first fluid, and freezing the first fluid.

In one example, the first fluid is an emulsion of acrylic polymer particles in water. A surfactant is typically used to keep the particles suspended. The emulsion is a clear viscous fluid that can be mixed with pigment to give it a tint (transparent) or deep color (opaque). The first fluid solidifies by the evaporation of water and the “fusing” of the particles when they contact each other. The resulting material has microscopic gaps between the fused particles which trap the pigment particles. This structure can also be used for trapping functional materials that react to light, radiation, heat, chemicals, biological elements, etc.

In another example, the first fluid includes a hardener and monomers, oligomers, polymeric particles, or a combination thereof. The hardener chemically fuses the polymeric particles together or polymerizes the monomers or oligomers. Suitable hardeners include amines (e.g., aliphatic amines, amine adducts, amine terminated polyamides). Two part (resin+hardener) systems solidify quickly and result in a solid/less porous material that is resistant to abrasion, moisture, and chemical attack. These dendritic structures can be used in harsh environments. Steel reinforced epoxy is a one example of this type of dendritic structure, as the resin binds strongly to the metal particles as well as to itself, forming a strong material that is resistant to mechanical forces and heat.

In yet another example, the first fluid includes UV curable resins. UV curable resins can include epoxy monomers that are polymerized by a photo-initiator under exposure to ultraviolet light. The dendritic structure solidifies quickly under UV illumination, with a short, controllable curing time.

In yet another example, a dendritic structure is solidified by crystallization. First fluids suitable for crystallization include honey and other sugar solutions (e.g., syrups). Crystallization can be achieved by heating after formation of the dendritic structure to promote crystallization.

In yet another example, solidification can be achieved by cooling (e.g., freezing) a dendritic structure from an elevated temperature. A suitable first fluid includes carnauba wax at a temperature of about 50-60° C. Subsequent cooling to room temperature results in solidification of the dendritic structure. In addition to carnauba wax, first fluids that include shellac and beeswax can also be solidified by cooling.

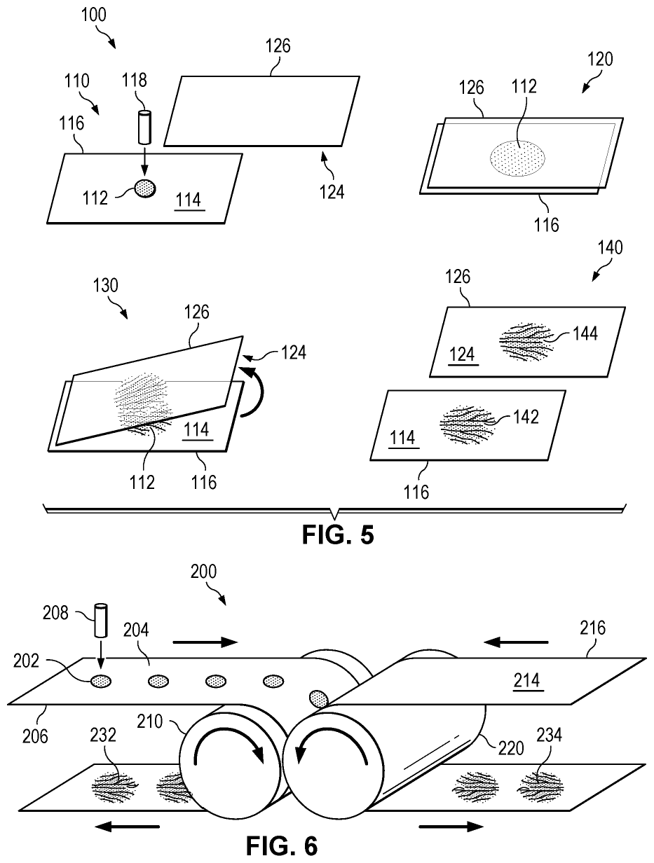

FIG. 5 depicts process 100 for fabricating dendritic structures. In 110, first fluid 112 is disposed on surface 114 of first substrate 116 with nozzle 118. In 120, first fluid 112 is contacted with surface 124 of second substrate 126, and the first fluid spreads between surface 114 of first substrate 116 and surface 124 of second substrate 126. Surface 114 of first substrate 116 and surface 124 of second substrate 126 at least partially confine first fluid 112, and surface 114 of first substrate 116 and surface 124 of second substrate 126 are separated by first fluid 112 at a region between surface 114 of first substrate 116 and surface 124 of second substrate 126. In 130, first substrate 116 and second substrate 126 are separated (i.e., the distance between surface 114 of first substrate 116 and surface 124 of second substrate 126 is increased), thereby allowing the second fluid (e.g., air) to penetrate first fluid 112 at the region, such that the second fluid is in direct contact with first fluid 112. The temperature at which the dendritic structure is formed is referred to herein as the “formation temperature.” A viscosity of first fluid 112 exceeds that of the second fluid at the formation temperature. In some cases, substrate 116 and second substrate 126 are submerged in or surrounded by the second fluid. In 140, first stochastically branched pattern 142 and second stochastically branched pattern 144 are shown on surface 114 of first substrate 116 and surface 124 of second substrate 126, respectively.

As depicted in FIG. 5, a thin layer of first (more viscous) fluid 112 is provided between surfaces 114 and 124 to form an assembly, and first fluid 112 is contacted with second (lower viscosity) fluid 124 at a first edge of the assembly such that a distance between surfaces 114 and 124 is on the order of a few microns to several hundred microns. Surfaces 114 and 124 are then separated from the first edge of the assembly to a second edge of the assembly in the presence of second fluid 122 to allow the rapid ingress of the second fluid as a distance between surfaces 114 and 124 is increased, resulting in the formation of unique stochastically branching pattern 142 on surface 114 of first substrate 116 and unique stochastically branching pattern 144 on surface 124 of first substrate 126, respectively. Surfaces 114, 124 can be substantially planar and parallel to each other.

FIG. 6 depicts process 200 for continuous production of dendritic structures. First fluid 202 is disposed on surface 204 of first substrate 206 with nozzle 208, and first substrate 206 is advanced clockwise around first roller 210. First fluid 202 is compressed between surface 204 of first substrate 206 and surface 214 of second substrate 216 as first roller 210 rotates clockwise and second roller 220 rotates counterclockwise. Substrates 206, 216 can be subjected to pressure in a range of about 50 g to about 5 kg between rollers 210, 220 (e.g., at a location where roller 210 contacts roller 220). As first substrate 206 and second substrate 216 advance about rollers 210 and 220, surface 204 and surface 214 are separated, yielding first stochastically branched pattern 232 on surface 204 of first substrate 206 and stochastically branched pattern 234 on surface 214 of second substrate 216.

In process 200, first fluid 202 is typically disposed on first substrate 204 in droplet sizes in a range of about 2 μL to about 400 μL. The droplets can be disposed on first substrate 204 in a line or in an array. A spacing between the droplets can be selected such that the resulting dendritic structures are discrete (e.g., discrete dendritic structures in a one-dimensional or two-dimensional array) or are continuous (e.g., intergrown dendritic structures). The directionality of pressure application as substrates 206, 216 advance through rollers 210, 220 results in a growth pattern with branches in a limited angular orientation. In some cases, the branches are arranged within an arc of about 120°, about 110°, about 100° arc, or about 90° centered at a base of the dendritic structure.

Dendritic structures formed by the manual process depicted in FIG. 5 typically have a ridge height (distance from the surface of the substrate to the highest point on the dendritic structure, measured perpendicular to the surface of the substrate) greater than that of dendritic structures formed by the continuous process depicted in FIG. 6. This difference can be attributed at least in part to the greater pressure applied to the first fluid in the continuous process.

In embodiments depicted in FIGS. 5 and 6 as well as other embodiments, the first fluid can include a gel, an oil, a polymer (e.g., a solubilized polymer or an emulsion of polymer particles in a solvent), or polymerizable monomers (e.g., (meth)acrylate monomers). The first fluid can be solidified (e.g., dried or cured) by evaporation of the solvent or exposure to air or light (e.g., UV radiation). In some cases, the first fluid includes a hardener (e.g., a free radical initiator or a photoinitiator). Suitable first fluids include acrylic paint media and steel-reinforced acrylic. In one example, acrylic paint media is an emulsion of acrylic resin particles in a solvent (e.g., water). In some cases, the emulsion includes one or more additional types of polymeric particles. The acrylic resin and other polymer particles are generally insoluble in water. The emulsion typically includes one or more pigments and surfactants. As the water evaporates after formation of the dendritic structure, the polymeric particles are drawn closer, until they touch and fuse together. This coalescence and produces a honeycomb-like pattern. Pigment particles are trapped in the honeycomb pattern, producing a viscoelastic paint film that is highly flexible with great adhesion. The elasticity of a multi-fluid dendrite can be reduced by altering the composition of an emulsion used to make the dendrite (e.g., by adding a hardener) or by annealing the dendrite to melt the polymeric particles and thus further fuse the particles together.

In some cases, the first fluid is food safe. Examples of suitable food-safe materials include Generally Recognized as Safe (GRAS) substances, such as glycerin, gelatin, wax, and polyvinyl alcohol.

The first fluid is selected to have a contact angle on the surface of the first substrate in a range of 60° to 70°. In some cases, the first fluid is colorless. In certain cases, the first fluid can include a colorant to enhance visibility of the dendritic structure. In some cases, the first fluid is optically transparent. In some cases, the first fluid includes a fluorescent substance that fluoresces when irradiated with light (e.g., ultraviolet light). The first fluid can be electrically conductive or non-conductive.

Particulate matter can be combined with the first fluid prior to deposition or on the uncured first fluid after dendrite formation. The particulate matter can be in forms such as flakes or crystals. The particulate matter can be electrically conductive (e.g., metallic) or non-conductive. Examples of food-safe, non-conductive particles include crystals of sugar, salt, gelatin, or the like. A size of the particulate matter is typically in a range of about 1 μm to about 400 μm. In some cases, the particulate matter includes nanoscale aggregates. A density of the particulate matter in the first fluid (e.g., number of particles per microliter of fluid) is typically in a range of 10 to 10,000.

Examples of suitable second fluids include air or other gasses, organic solvents (e.g., acetone, hexane, and alcohols such as methanol, ethanol, and isopropanol), and penetrating oils (e.g., WD-40). The second fluid can be optically transparent. In some cases, the second fluid includes a colorant. The colorant may be the same as or different than a colorant present in the first fluid.

The first fluid, the second fluid, or both can independently include a colorant. In some cases, the first fluid, the second fluid, or both include a surfactant (e.g., detergent) to reduce surface tension. The first fluid can be a mixture of two or more fluids, and the second fluid can independently be a mixture of two or more second fluids, or both. The two or more fluids may be mixed to form a homogenous fluid before use.

The first and second fluids are typically selected to have a low interfacial tension (e.g., less than about 40 mJ/m²). This limits the inhibition of small branches due to surface tension effects. A variety of dendritic morphologies can be created, based at least in part on properties of the first and second fluids and the rate of separation of the two surfaces (e.g., about 0.1 cm/s to about 250 cm/s). The rate of separation of the surfaces is a factor in dendrite morphology, with slower separation (less than about 1 cm/s) leading to denser patterns (high fractal dimension, greater than about 1.5) and patterns that are more irregular (more like “diffusion limited aggregates” in shape).

In some cases, the first fluid has a viscosity in a range of about 0.5 Pa·s to about 10 Pa·s at room temperature. The viscosity of the first fluid is typically at least about 100 times greater than the viscosity of the second fluid at the formation temperature. The resulting dendritic structures have a high information density (i.e., a vast number of possible versions), and can be “read” (identified) with appropriate algorithms.

In general, a first fluid in the higher range of viscosity (greater than about 1 Pa·s) yields a three-dimensional dendritic structure with a variable thickness with respect to the surface on which it is formed. This variable thickness can be detected using low angle illumination, which will light up facets that are facing the light source to create bright features in the image. Different illumination directions will light up different facets, so the presence of a three dimensional pattern (rather than a two dimensional pattern) is apparent. The way that the first fluid separates when a distance between the surface of the first substrate and the surface of the second substrate are separated can also lead to unique topography in each pair of dendrites. That is, there can be subtle thickness variations along the length of each branch, increasing the difficulty of cloning of these patterns.

Dendritic structures fabricated as described herein can be functionalized by including one or more additives in the first fluid, and attaching the dendritic structure as a label on an item (e.g., produce, pharmaceuticals, etc.). In one example, an additive that changes color irreversibly when a particular temperature is exceeded can be used as an indicator that a cold chain has been broken. In another example, an additive that changes color irreversibly when the dendritic structure is exposed to light (e.g., for a selected length of time or at a selected wavelength) can be used as an indicator of exposure to light. Other additives include additives that change color irreversibly when the dendritic structure is exposed to water or a threshold humidity level, a selected type of radiation (e.g., gamma radiation, X-rays, etc.), specific chemicals (e.g., chorine), or biological agents (e.g., bacteria such as E. coli).

Authenticating a stochastically branching pattern formed by processes described herein can include measuring a height of each point of a first multiplicity of points on a first stochastically branching pattern from a surface from which the first stochastically branching pattern extends, comparing the height of each of the first multiplicity of points with a height of each of a second multiplicity of corresponding points on a second stochastically branching pattern, and assessing a difference in height between each corresponding point of the first multiplicity of points and the second multiplicity of points. In some cases, authenticating a stochastically branching pattern, the method includes assessing an optical signal from a stochastically branching pattern that contains reflective particles.

Multi-fluid dendrites also have natural anti-tamper qualities. For multi-fluid dendrites formed of viscoelastic polymers (e.g., include amorphous polymers, semicrystalline polymers, and biopolymers), the dendrites retain their shape through normal flexing during use, but typically distort when stretched. In one example, an acrylic multi-fluid dendrite might maintain its shape during the slight vertical movement of a label on a produce item during transport and handling, but distort if the label is peeled off the produce item. The distortion during removal of the label may result in permanent lengthening of dendrite features along a particular axis. If the label is reused, this damage would be visible during subsequent inspection, especially when the tampered version is compared with the original image. The presence of scattering centers in the form of metal or other reflective particles, distances between the particles will change if the acrylic (or other medium) is stretched, which can be detected optically. Damage sustained during tearing or stretching is evident in the polarized light image, as well as the geometric distortion of the dendrite, providing multiple methods of detection.

These distortions will be most detectible during optical inspection (with unpolarized and polarized light). Feature-by-feature comparison with the original (undistorted) pattern can be used to detect such damage. In addition, machine learning (ML) can be used to train a system to recognize distortions caused by illicit breaking or removal. In this approach, two training sets, images of undistorted and distorted dendrites, can be used to define the parameters for system operation, so that a neural network can automatically detect and flag tampering issues.

Some embodiments described in the disclosure are provided below.

Embodiment 1 is a method of assessing distortion of a dendrite, the method comprising:
obtaining an optical image of the dendrite;
assessing geometric features of the dendrite based on the optical image;
comparing the geometric features of the dendrite to corresponding geometric features of a corresponding undistorted dendrite;
assessing a distortion of the geometric features of the dendrite relative to the corresponding geometric features of the corresponding undistorted dendrite; and
identifying the dendrite as distorted if the distortion exceeds a threshold value.

Embodiment 2 is a method of embodiment 1, wherein the threshold value is at least 10% of the corresponding value of corresponding undistorted dendrite.

Embodiment 3 is a method of embodiments 1 or 2, wherein the geometric features comprise branches, angles between branches, and thicknesses of branches.

Embodiment 4 is a method of any one of embodiments 1 through 3, wherein the distortion comprises alteration of a length of a branch of the dendrite.

Embodiment 5 is a method of any one of embodiments 1 through 4, wherein the distortion comprises alteration of an angle between branches of the dendrite.

Embodiment 6 is a method of any one of embodiments 1 through 5, wherein the distortion comprises alteration in a thickness of a branch of the dendrite.

Embodiment 7 is a method of any one of embodiments 1 through 6, wherein the distortion comprises a discontinuity in a branch of the dendrite.

Embodiment 8 is a method of any one of embodiments 1 through 7, wherein obtaining the optical image comprises irradiating the dendrite with polarized or unpolarized light.

Embodiment 9 is a method of any one of embodiments 1 through 8, further comprising, after identifying the dendrite as distorted, identifying an item to which the dendrite is coupled as compromised.

Embodiment 10 is a method of any one of embodiments 1 through 9, wherein the corresponding features of the corresponding undistorted dendrite are stored in a database.

Embodiment 11 is a method of any one of embodiments 1 through 10, wherein assessing the distortion comprises assessing a probability that differences in the geometric features of the dendrite and the corresponding features of the corresponding undistorted dendrite are attributed to severing a branch of the dendrite.

Embodiment 12 is a method of any one of embodiments 1 through 11, wherein assessing the distortion comprises assessing a probability that differences in the geometric features of the dendrite and the corresponding features of the corresponding undistorted dendrite are attributed to stretching a branch of the dendrite.

Embodiment 13 is a method of any one of embodiments 1 through 12, wherein obtaining the optical image of the dendrite comprises taking a photograph of the dendrite.

Embodiment 14 is a method of embodiment 13, wherein taking the photograph of the dendrite comprises taking a photograph with a cell phone.

Embodiment 15 is a method of embodiment 14, wherein the corresponding geometric features are accessed via an application on the cell phone.

Embodiment 16 is a method of any one of embodiments 1 through 15, wherein the dendrite is metallic.

Embodiment 17 is a method of any one of embodiments 1 through 15, wherein the dendrite is polymeric.

Embodiment 18 is a method of embodiment 17, wherein the dendrite is optically transparent.

Embodiment 19 is a method of any one of embodiments 1 through 18, wherein the dendrite comprises metallic particles.

Embodiment 20 is a method of any one of embodiments 17 through 19, wherein the dendrite comprises an acrylic polymer.

Embodiment 21 is a method of any one of embodiments 1 through 20, further comprising training a system to recognize the distortion of the geometric features of the dendrite.

Embodiment 22 is a method of embodiment 21, further comprising altering one or more of the geometric features of the dendrite to yield a reference distorted dendrite.

Embodiment 23 is a method of embodiment 22, further comprising obtaining an optical image of the reference distorted dendrite.

Embodiment 24 is a method of embodiment 23, further comprising assessing geometric features of the reference distorted dendrite.

Embodiment 25 is a method of embodiment 24, further comprising comparing the geometric features of the reference distorted dendrite with the corresponding geometric features of the dendrite.

Embodiment 26 is a method of embodiment 25, further comprising identifying, based on the comparing, a difference in a selected geometric feature of the dendrite and the corresponding feature of the reference distorted dendrite.

Embodiment 27 is a method of any one of embodiments 22 through 26, wherein altering the one or more of the geometric features of the dendrite comprises stretching or breaking a branch of the dendrite.

Embodiment 28 is a method of any one of embodiments 22 through 27, wherein altering the one or more of the geometric features of the dendrite comprises removing the substrate from a surface.

Embodiment 29 is a method of any one of embodiments 22 through 28, wherein altering the one or more of the geometric features of the dendrite comprises severing a portion of the substrate.

Embodiment 30 is a method of any one of embodiments 26 through 29, wherein the selected geometric feature is a length of a branch, an angle between branches, a thickness of a branch, or a discontinuity of a branch of the dendrite.

Embodiment 31 is a method of any one of embodiments 23 through 30, wherein obtaining the optical image of the reference distorted dendrite comprises taking a photograph of the reference distorted dendrite.

Embodiment 32 is a method of assessing distortion of a dendrite, the method comprising:
obtaining an optical image of the dendrite; and
assessing a distortion of geometric features,
wherein assessing the distortion of the geometric features comprises identifying a discontinuity in a branch of the dendrite.

Embodiment 33 is a method of embodiment 32, wherein obtaining the optical image comprises irradiating the dendrite with polarized or unpolarized light.

Embodiment 34 is a method of training a system to recognize distortions caused by tampering with a dendrite disposed on a substrate, the method comprising, for each dendrite of a multiplicity of dendrites:
obtaining an image of the dendrite;
assessing geometric features of the dendrite;
altering one or more geometric features of the dendrite to yield a distorted dendrite;
obtaining an image of the distorted dendrite;
assessing geometric features of the distorted dendrite;
comparing the geometric features of the distorted dendrite with the corresponding geometric features of the dendrite; and
identifying, based on the comparing, a difference in a selected geometric feature of the dendrite and the corresponding feature of the dendrite.

Embodiment 35 is a method of embodiment 34, wherein altering one or more of the geometric features of the dendrite comprises stretching or breaking a branch of the dendrite.

Embodiment 36 is a method of embodiments 34 or 35, wherein altering one or more of the geometric features of the dendrite comprises removing the substrate from a surface.

Embodiment 37 is a method of any one of embodiments 34 through 36, wherein, for each dendrite of the multiplicity of dendrites, comparing the geometric features of the distorted dendrite with the corresponding geometric features of the dendrite comprises comparing the selected geometric feature identified with respect to another one of the dendrites.

Embodiment 38 is a method of any one of embodiments 34 through 37, wherein the selected geometric feature is a length of a branch, an angle between branches, a thickness of a branch, or a discontinuity of a branch of the dendrite.

Although this disclosure contains many specific embodiment details, these should not be construed as limitations on the scope of the subject matter or on the scope of what may be claimed, but rather as descriptions of features that may be specific to particular embodiments. Certain features that are described in this disclosure in the context of separate embodiments can also be implemented, in combination, in a single embodiment. Conversely, various features that are described in the context of a single embodiment can also be implemented in multiple embodiments, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular embodiments of the subject matter have been described. Other embodiments, alterations, and permutations of the described embodiments are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results.

Accordingly, the previously described example embodiments do not define or constrain this disclosure. Other changes, substitutions, and alterations are also possible without departing from the spirit and scope of this disclosure.

What is claimed is:

1. A method of assessing distortion of a dendrite, the method comprising:
obtaining an optical image of the dendrite;
assessing geometric features of the dendrite based on the optical image;
comparing the geometric features of the dendrite to corresponding geometric features of a corresponding undistorted dendrite;
assessing a distortion of the geometric features of the dendrite relative to the corresponding geometric features of the corresponding undistorted dendrite; and
identifying the dendrite as distorted if the distortion exceeds a threshold value.

2. The method of claim 1, wherein the geometric features comprise branches, angles between branches, and thicknesses of branches.

3. The method of claim 1, wherein the distortion comprises alteration of a length of a branch of the dendrite.

4. The method of claim 1, wherein the distortion comprises alteration of an angle between branches of the dendrite.

5. The method of claim 1, wherein the distortion comprises alteration in a thickness of a branch of the dendrite.

6. The method of claim 1, wherein the distortion comprises a discontinuity in a branch of the dendrite.

7. The method of claim 1, wherein obtaining the optical image comprises irradiating the dendrite with polarized or unpolarized light.

8. The method of claim 1, further comprising, after identifying the dendrite as distorted, identifying an item to which the dendrite is coupled as compromised.

9. The method of claim 1, wherein the corresponding features of the corresponding undistorted dendrite are stored in a database.

10. The method of claim 1, wherein assessing the distortion comprises assessing a probability that differences in the geometric features of the dendrite and the corresponding features of the corresponding undistorted dendrite are attributed to severing a branch of the dendrite.

11. The method of claim 1, wherein assessing the distortion comprises assessing a probability that differences in the geometric features of the dendrite and the corresponding features of the corresponding undistorted dendrite are attributed to stretching a branch of the dendrite.

12. The method of claim 1, wherein obtaining the optical image of the dendrite comprises taking a photograph of the dendrite.

13. The method of claim 12, wherein taking the photograph of the dendrite comprises taking a photograph with a cell phone.

14. The method of claim 13, wherein the corresponding geometric features are accessed via an application on the cell phone.

15. The method of claim 1, wherein the threshold value is at least 10% of the corresponding value of corresponding undistorted dendrite.

16. The method of claim 1, wherein the dendrite is metallic.

17. The method of claim 1, wherein the dendrite is polymeric.

18. The method of claim 17, wherein the dendrite is optically transparent.

19. The method of claim 17, wherein the dendrite comprises metallic particles.

20. The method of claim 17, wherein the dendrite comprises an acrylic polymer.

21. The method of claim 1, further comprising training a system to recognize the distortion of the geometric features of the dendrite.

22. The method of claim 21, further comprising altering one or more of the geometric features of the dendrite to yield a reference distorted dendrite.

23. The method of claim 22, further comprising obtaining an optical image of the reference distorted dendrite.

24. The method of claim 23, further comprising assessing geometric features of the reference distorted dendrite.

25. The method of claim 24, further comprising comparing the geometric features of the reference distorted dendrite with the corresponding geometric features of the dendrite.

26. The method of claim 25, further comprising identifying, based on the comparing, a difference in a selected geometric feature of the dendrite and the corresponding feature of the reference distorted dendrite.

27. The method of claim 22, wherein altering the one or more of the geometric features of the dendrite comprises stretching or breaking a branch of the dendrite.

28. The method of claim 22, wherein altering the one or more of the geometric features of the dendrite comprises removing the substrate from a surface.

29. The method of claim 28, wherein altering the one or more of the geometric features of the dendrite comprises severing a portion of the substrate.

30. The method of claim 26, wherein the selected geometric feature is a length of a branch, an angle between branches, a thickness of a branch, or a discontinuity of a branch of the dendrite.

31. The method of claim 23, wherein obtaining the optical image of the reference distorted dendrite comprises taking a photograph of the reference distorted dendrite.

32. The method of claim 1, wherein the threshold value is at least 10% of the corresponding value of corresponding undistorted dendrite.

33. A method of assessing distortion of a dendrite, the method comprising:
obtaining an optical image of the dendrite; and
assessing a distortion of geometric features,
wherein assessing the distortion of the geometric features comprises identifying a discontinuity in a branch of the dendrite.

34. The method of claim 33, wherein obtaining the optical image comprises irradiating the dendrite with polarized or unpolarized light.
